(19) United States
(12) Patent Application Publication
(10) Pub. No.: US 2010/0205321 A1
(43) Pub. Date: Aug. 12, 2010

(54) NEGOTIABLE AND ADAPTABLE PERIODIC LINK STATUS MONITORING

(75) Inventors: Judit Martinez Bauza, San Diego, CA (US); Soham Sheth, San Diego, CA (US); Dinesh Dharmaraju, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/370,398

(22) Filed: Feb. 12, 2009

(51) Int. Cl. G06F 15/16

(52) U.S. Cl. 709/237

(57) ABSTRACT

A method and system for negotiating and updating a periodicity for link status notification messages between a host and at least one client in a digital communication system. The periodicity is negotiated during an association handshake protocol. This allows the periodicity to be updated during the association to adapt to changing conditions in the data link.

### REFERENCE TO CO-PENDING APPLICATIONS FOR PATENT

The present application for patent is related to the following co-pending U.S. Patent Applications:

“Wireless Architecture for a Traditional Wire-Based Protocol”, U.S. patent application Ser. No. 11/624,642, filed on Jan. 18, 2007;

“Wireless Architecture for a Traditional Wire Based Protocol”, U.S. patent application Ser. No. 11/624,634, filed on Jan. 18, 2007;

“Wireless Architecture for a Traditional Wire-Based Protocol”, U.S. patent application Ser. No. 12/179,411, filed Jul. 24, 2008;

“Apparatus and Methods for Establishing Client-Host Associations within a Wireless Network”, U.S. patent application Ser. No. 12/098,025, filed Apr. 4, 2008; and

“ASSOCIATION PROCEDURE TO ENABLE MULTIPLE MULTICAST STREAMS”, U.S. patent application Ser. No. ______, filed on evendate herewith.

### BACKGROUND

1. Field

The presently claimed invention relates generally to communication systems, and more specifically to a method, system, and computer program for communication link status monitoring.

2. Background

The Wireless Mobile Digital Display Interface (WMDDI) is an extension of the Mobile Display Digital Interface (MDDI) standard as defined in U.S. Pat. No. 6,760,772B2 and other related patent applications, to wireless networks. The WMDDI protocol supports secure data exchange between one host-device, typically a mobile device such as a cell-phone or Personal Digital Assistant (PDA), and a wide range of simultaneously accessible client-devices, typically wireless displays with embedded capabilities (such as audio/video decoding and reproduction, or Human Interface Device (HID) capabilities). Direct communication between client-devices is not supported; only client to host and host to client asymmetric communication is supported. The communication is asymmetric in the sense that much larger amount of data is expected to be exchanged in the forward link, that is, from the host to the client.

The host and the client require the establishment of a WMDDI association prior to the exchange of multimedia or control data. Some details of this process are described in the following related patent applications: “Wireless Architecture for a Traditional Wire-Based Protocol”, U.S. patent application Ser. No. 11/624,642, filed on Jan. 18, 2007; “Wireless Architecture For a Traditional Wire Based Protocol”, U.S. patent application Ser. No. 11/624,634, filed on Jan. 18, 2007; “Wireless Architecture for a Traditional Wire-Based Protocol”, U.S. patent application Ser. No. 12/179,411, filed Jul. 24, 2008; and “Apparatus and Methods for Establishing Client-Host Associations Within a Wireless Network”, U.S. patent application Ser. No. 12/098,025, filed Apr. 4, 2008. A WMDDI system has a single host-device and one or more client-devices with whom the host-device is able to establish an association and secure communication.

The association state prevails until either the host or the client requests the dissociation. However, under certain circumstances, such as radio-interferences and increasing distance between devices, the link between the host and the client may deteriorate and even be lost. In such circumstances, the exchange of data will be corrupted or stopped.

If there's no feedback message to acknowledge the reception, or this acknowledgement happens after large amounts of data have been sent, or the deterioration happens during a period in which the devices are not exchanging data, it may take too long or even may not be possible to detect that the link has been corrupted or lost. Likewise, with the present systems, it is not possible to take any preventive measures to avoid or correct the loss or corruption of the link. Therefore, there is a need for a system to provide constant monitoring of the link status.

### SUMMARY

Embodiments disclosed herein address the above stated needs by providing an improvement in the WMDDI association procedure that allows negotiating and updating the periodicity of link status monitoring messages to adapt to device requirements or changing conditions during association.

In WMDDI systems, where the host is typically a portable device, such as a cell-phone, or PDA, that can associate with multiple heterogeneous clients, such as several displays in a room or a car, it is desirable to reduce power consumption in the host and allow flexibility in the link status exchange periodicity to cope with changing conditions. Therefore, the presently claimed invention describes a link status (LS) monitoring procedure that allows the periodicity to be negotiated during the association handshake protocol to adapt to host and clients power/processing capabilities and constraints. This system allows the periodicity to be updated during the association state to adapt to changing conditions in the channel quality, client/host power and processing resources, relevance of the data being exchanged, as well as other described conditions. The claimed system does not increase the number of link query messages sent by the host as the number of clients in the system increases. Further, the claimed invention provides a way for broadcast/multicast data transmissions with no-ACK to evaluate the quality of the link and adapt accordingly.

### BRIEF DESCRIPTION OF THE DRAWINGS

FIG. 1 is a timeline of link status notifications using the first aspect of the claimed invention.

FIG. 2 is a timeline of link status notifications using the second aspect of the claimed invention.

FIG. 3 is a timeline of link status notifications using the third aspect of the claimed invention.

FIG. 4 graphically shows the aspect of negotiating the link status periodicity.

FIG. 5 graphically shows a host initiated update during the association stage.

FIG. 6 graphically shows a second aspect of the claimed invention whereby the host updates the previously negotiated periodicity because of an association with an additional client.

FIG. 7 graphically shows a third aspect showing a client initiated update of the periodicity during the association stage.

### DETAILED DESCRIPTION

The word “exemplary” is used herein to mean “serving as an example, instance, or illustration.” Any aspect described herein as “exemplary” is not necessarily to be construed as preferred or advantageous over other aspects.

The presently claimed invention provides for an efficient strategy to perform the link status monitoring, a mechanism to facilitate the negotiation of the link status monitoring periodicity, during the association handshake protocol between the host and the client and a mechanism to adapt the link status monitoring periodicity according to the host or client requirements, during the association.

In the association state, it is useful that the host and the client keep monitoring their link status on a periodic basis. The link status notification shall convey link status parameters such as, but not limited to: average transmission Physical Layer (PHY) rate, average reception PHY rate, average transmission payload size, average reception payload size, average number of retransmissions, frame rate error, received signal strength indication, and link quality indication. According to the value of these parameters, the device may take a corrective action or may decide to notify the user.

If the link status notification is not received for a certain time, based on an expected periodicity, the device may assume that the link has been lost and may enter the dissociated state. Given the heterogonous character of the devices in the systems, the changing conditions of the channel quality and the character of the data transmission, it is highly desirable to have systems able to adapt the link status monitoring periodicity.

Examples for use of the presently claimed invention for monitoring the periodicity are: based on the processing capabilities, power consumption requirements or capabilities to enter the hibernation state, some portable devices may benefit from relaxing the monitoring periodicity to larger intervals; if a device is able to adapt to bad link quality conditions, by increasing transmission power, reducing the PHY bit rate, etc., it may require more frequent link status parameter updates, that is reduce the periodicity to shorter intervals, during certain channel conditions; and If the devices are not in the process of exchanging data, they may also want to relax the periodicity; and increase it when large amounts of data need to be exchanged without the possibility of acknowledgement, which may occur in multicast/broadcast scenarios.

### Link Status Monitoring Strategy

The link status notifications may be sent asynchronously by each device, or synchronously based on a query-response message exchange. The following three strategies are possible.

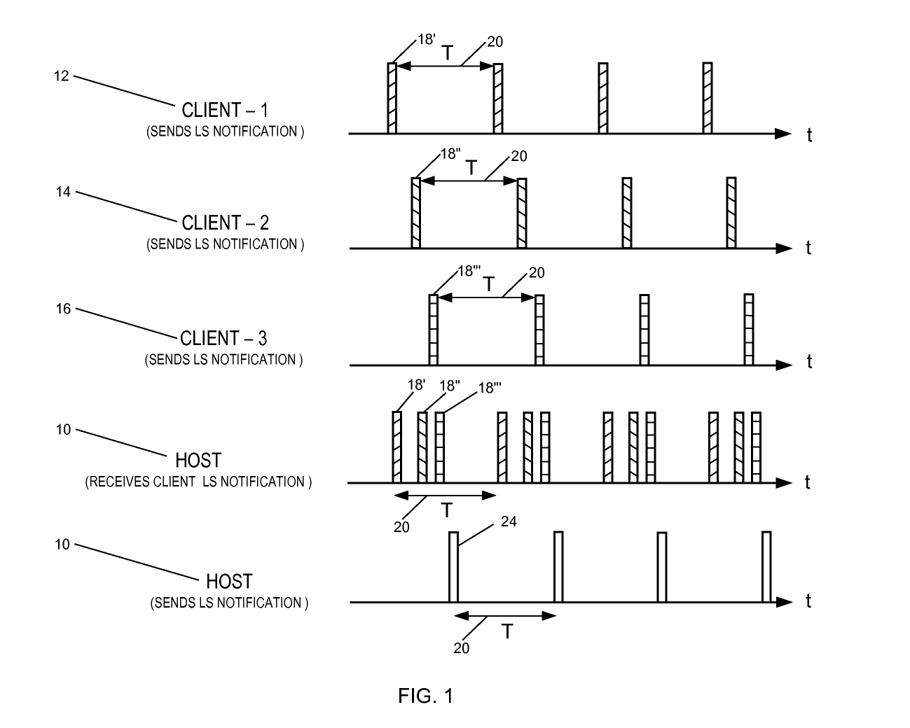

The first strategy is shown in FIG. 1, which is a graphic timeline with three clients and a host. Host 10 and the clients, client 1 12, client 2 14 and client 3 16, asynchronously send a link status notification message, according to a predefined or negotiated periodicity T 20. In this case, host 10 receives the notifications 18, client 1 notification 18′, client 2 notification 18″ and client 3 notification 18′″, from several clients at different instants of time within the period 20. A shown in FIG. 1, the instant each client sends a notification 18, host 10 receives and processes these notifications 18 distributed within a period T 20. Host 10 will send its link status notification 24 asynchronously of the reception of the client notifications 18, but following the same periodicity 20.

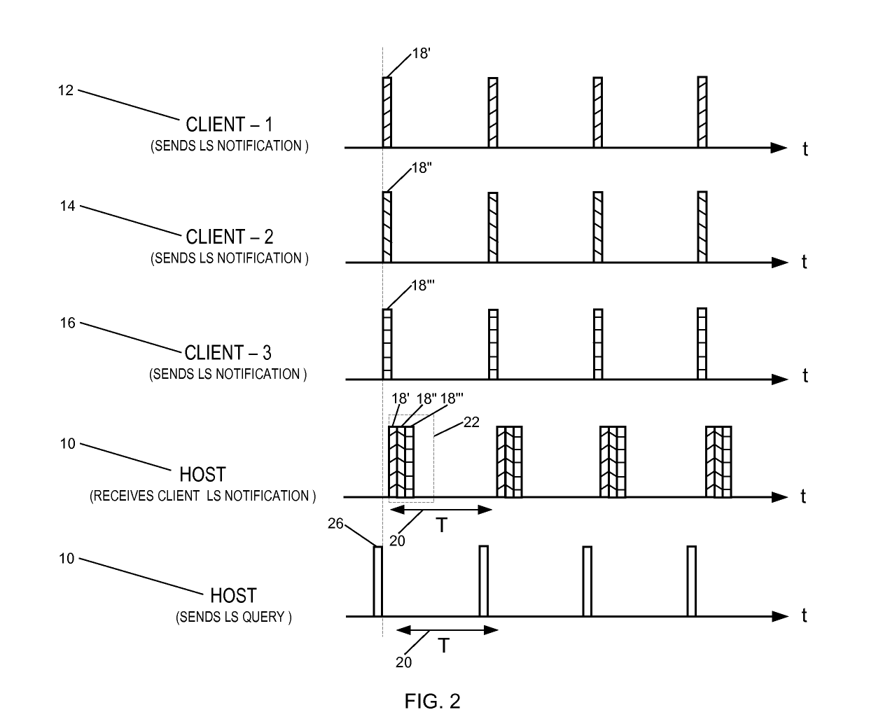

The second aspect is shown in FIG. 2. Host 10 sends a link status query 26 to the client-devices, client 1 12, client 2 14 and client 3 16, according to a predefined or negotiated periodicity T 20 and each client-device sends back a link status notification 18, client 1 12 sends its link status notification 18′, client 2 14 sends its link status notification 18″ and client 3 16 sends its link status notification 18′″, as shown. In this case, host 10 receives all link status notifications 18 within a window 22, because the link status query message 26 sent by host 10 synchronizes the link status notifications 18 of all clients.

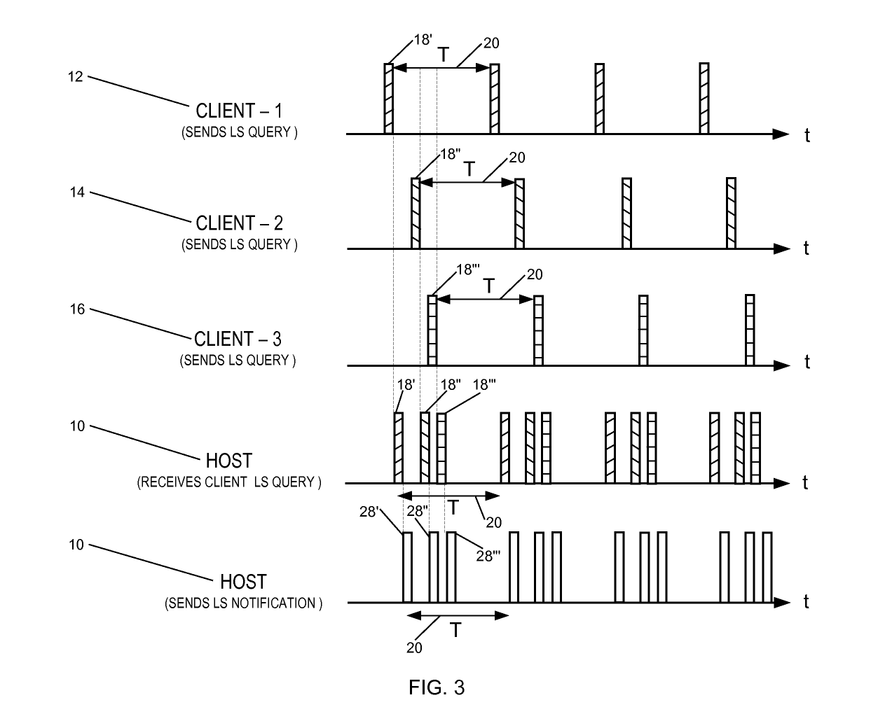

The third strategy includes the client-devices sending a link status query to the host according to a negotiated periodicity, and the host sends back a link status response to each client-device, as shown in FIG. 3. Host 10 and the clients, client 1 12, client 2 14 and client 3 16, asynchronously send a link status notification message, according to a predefined or negotiated periodicity T 20. In this case, host 10 receives the notifications 18, client 1 notification 18′, client 2 notification 18″ and client 3 notification 18′″, from several clients at different instants of time within the period 20. In this case, host 10, sends links status responses 28′, 28″ and 28′″ upon receipt of client generated link status notification messages 18. From the host perspective, this is a similar situation shown in FIG. 1 in the sense that the host receives the notifications from several clients at different instants of time within the period. The difference is that it will synchronize its link status response to each client query. Among the three strategies, the second aspect as shown in FIG. 2 offers the most efficient strategy for WMDDI systems, especially when all the devices support multicasting, although the other strategies are functional. In this situation, host 10 multicasts a link status notification 28′, 28″, and 28′″ which may include its own link status parameters, at a predefined/negotiated period T 20. All the clients, 12,14 and 16, send back a link status response 18 (which may include their own link status parameters) within a certain window of time, because the message sent by the host synchronizes the link status responses 18 of the clients 12,14 and 16.

A variation of the process previously described when host 10 and client 12, 14 and 16 have negotiated the response to be provided at certain multiples, wherein each client can negotiate a different multiple, of the host periodic link status query. In this process, each client sends the client status notification messages synchronized to the reception of multiple consecutive host link status inquiry messages, where the multiple value has been negotiated between the host and the client.

### Negotiating the Link Status Periodicity

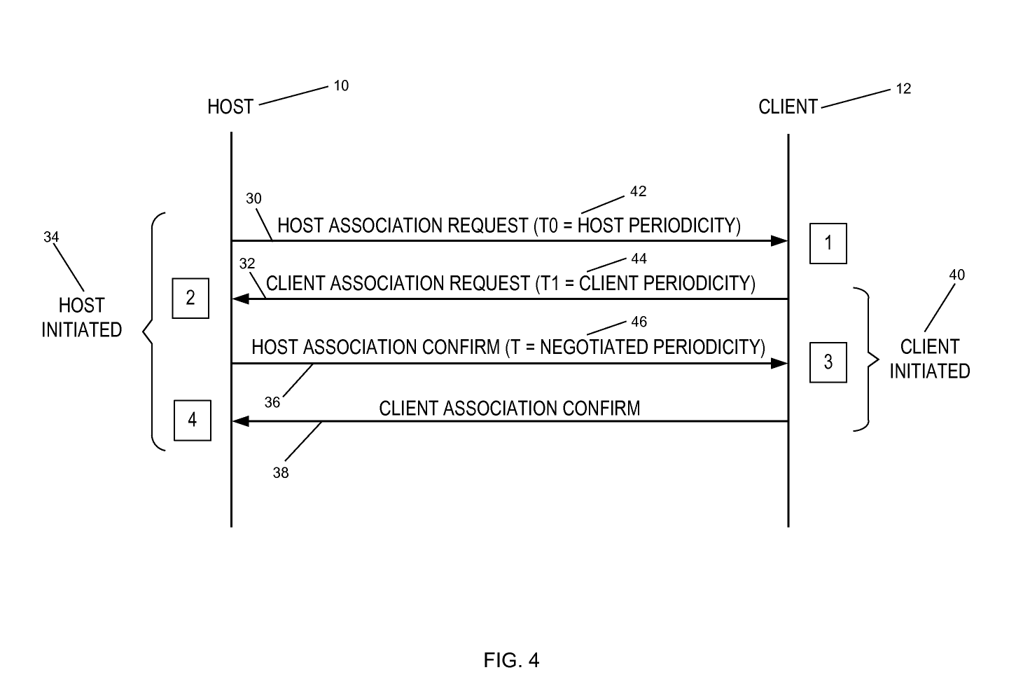

The periodicity of the link status monitoring may be negotiated during a 4-way or 3-way handshake association process. The handshake process is shown in FIG. 4. For a host-initiated association 34, host 10 initiates the association by sending a host association request message 30 that contains, among other fields, an initial host minimum supported periodicity, T0 42 for the LS messages that will be exchanged during the associated stage. Client 12 answers with a client association request message 32 that indicates the initial client minimum supported periodicity, T1 44 for the exchange of the LS messages. The values of T0 42 and T1 44 depend on the computational and power constraints of the host 10 and client 12 devices. Host 10 sends back a host association confirm message 36 with a negotiated periodicity T 46 that has to be greater or equal to the minimum client supported periodicity T1 44 and the minimum host supported periodicity T0 42. The selection of this negotiated periodicity T 46 by host 10 must take into account the minimum periodicity constraints imposed by all the clients already associated with host 10. Additionally, host 10 may also take into account other computational or power constraints for the selection of the negotiated periodicity T 46. Client 12 confirms, acknowledges and accepts the negotiated periodicity by sending a client association confirm message 38 to host 10. This example shows only a single client; however, this process is similar for multiple clients.

For a client-initiated association 40, the process follows the same steps as the host-initiated association, except that the host association request message 30 is not sent. Thus, the client-initiated association 40 involves a 3-way handshake process.

### Updating the Link Status Periodicity

During association, either host 10 or client 12 will be able to update the negotiated periodicity T 46 by sending update LS-periodicity and update LS-periodicity confirm messages, with a field containing the new periodicity. If for any reason, such as (a) a new client is associated to the host or (b) computational/power constraints, the host decides to modify the link status periodicity, it sends to all the clients an ‘Update LS Periodicity’ message 30 with the new periodicity value for the exchange of LS messages (which should comply with the initial minimum periodicity constraints exchanged during the association handshake with all the clients). If multicast or broadcast is supported, this message will be broadcasted/multicasted. All clients 12, 14, 16 will confirm acknowledge and acceptance of the new periodicity by sending an ‘Update LS Periodicity confirm’ message 38 to host 10.

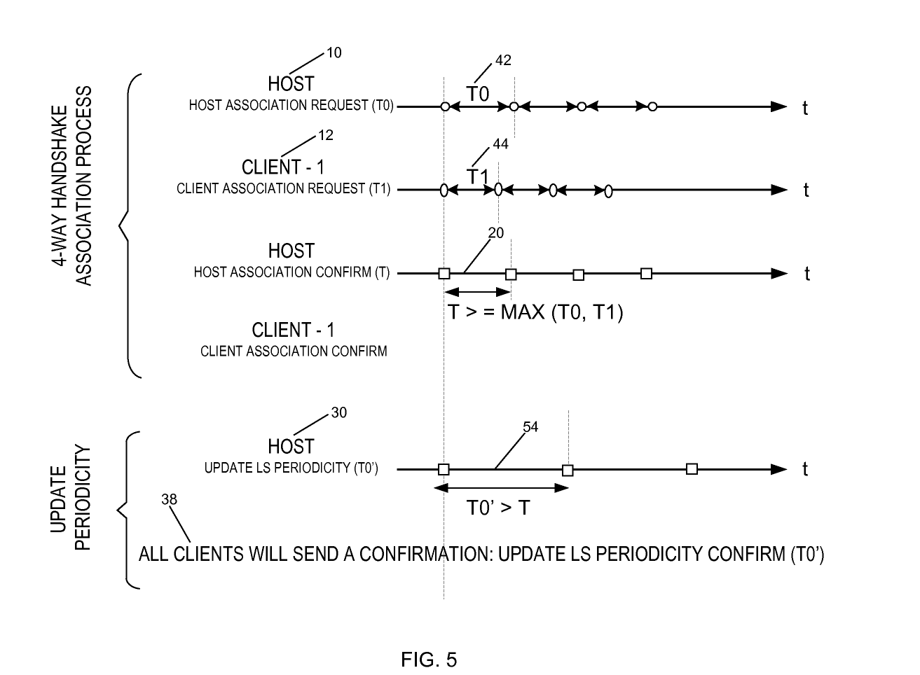

FIG. 5 graphically shows a first aspect for a host initiated update during the association stage. This aspect of the claimed invention is used when host 10 needs to update the initial host minimum supported periodicity T0 42 to an updated periodicity T0′ 54, such that T0′ 54>T 20, due to such reasons as new computational or power constraints.

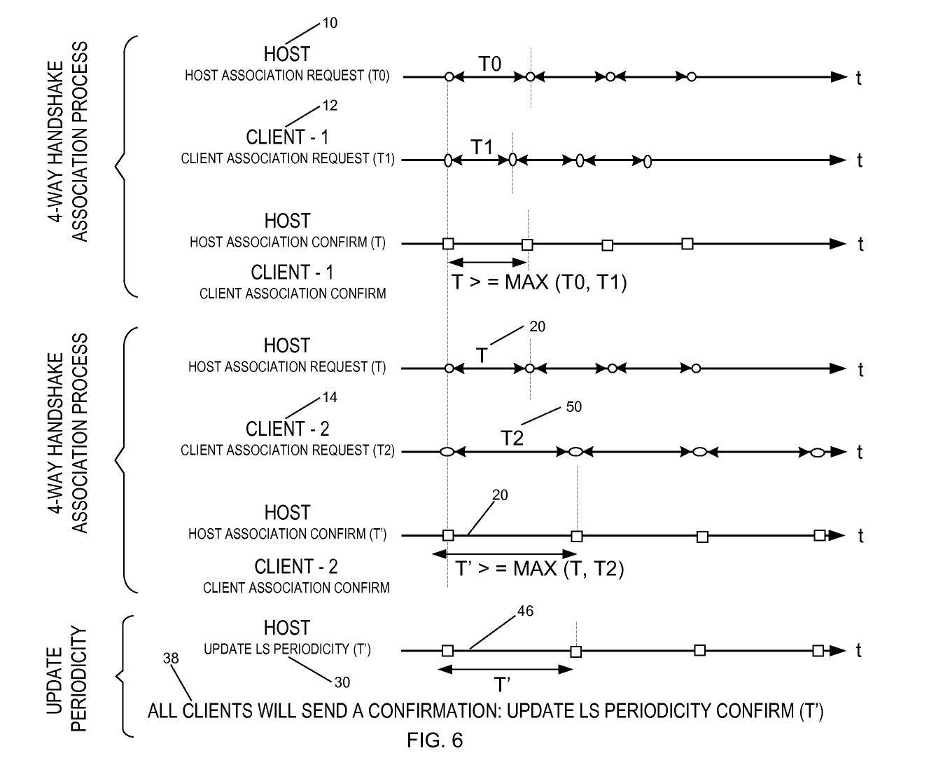

FIG. 6 graphically shows a second aspect where a host 10 is updating the previously negotiated periodicity due to the fact that host 10 has associated with an additional client, that is, client 2 14, with a minimum supported periodicity T2 50 such that T2 50>T 20. In this case, T′ 46≧T2 50.

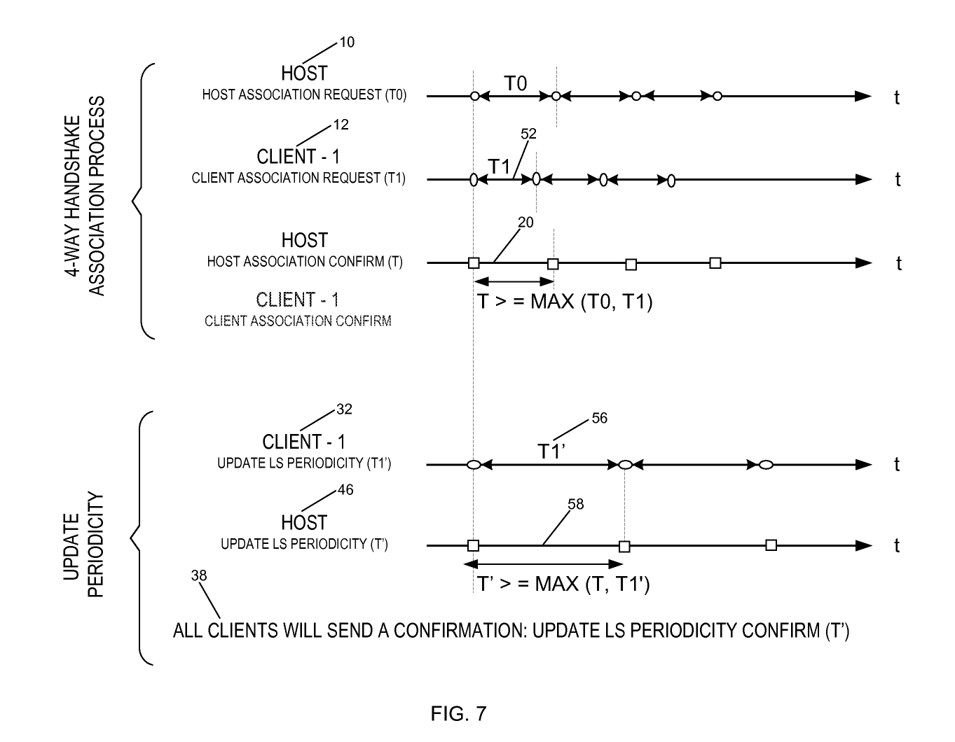

FIG. 7 graphically shows a third aspect showing a client initiated update of the periodicity selected during the association stage. If for any reason, such as computational/power constraints, client 1 12 modifies its minimum supported LS periodicity T1 52, it sends an ‘Update LS Periodicity’ 32 message to host 10 with the new periodicity value T1′ 56 for the exchange of LS messages. Host 10, based on this new request and other considerations, such as (a) existing periodicity constraint with other associated clients, (b) power/computational constraints, (c) current periodicity being used, sends an ‘Update LS Periodicity’ T′ message 46 with the new periodicity value T′ 58 for the exchange of LS messages. The new periodicity T′ 58 may be the same or different from the one that had been used so far for the LS messages exchange. If the new periodicity is the same, the message is only sent to the requesting client 1 12, and this client will confirm acknowledgement and acceptance of the new periodicity T′ 58 by sending an ‘Update LS Periodicity Confirm’ 38 message to host 10. If it is different, the message will be sent to all the clients. If multicast or broadcast is supported, this message will be broadcasted/multicasted. All the clients will confirm acknowledgement and acceptance of the new periodicity by sending an ‘Update LS Periodicity confirm’ 38 message to the host. Thus, if the new client periodicity, T1′ 46, is greater than T 20, then host 10 will send an update LS periodicity to all the clients with the new negotiated periodicity, T′ 58.

The mechanisms described above provide an improvement in the WMDDI association procedure that enables negotiating the periodicity to monitor the link status, according to device constraints, during 4-way or 3-way association handshake and updating the periodicity to monitor the link status, to adapt to changing conditions during the association state. It also provides several strategies to carry out the monitoring process.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the presently claimed invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the presently claimed invention. Various modifications to these aspects will be readily apparent to those skilled in the art, and the generic principles defined herein may be applied to other embodiments without departing from the spirit or scope of the presently claimed invention. Thus, the presently claimed invention is not intended to be limited to the aspects shown herein but is to be accorded the widest scope consistent with the principles and novel features disclosed herein.

1. A method of negotiating and updating a periodicity for link status notification messages between a host and at least one client in a digital communication system, the method comprising the steps of:
exchanging periodicity parameters between the host and the at least one client during a handshake association process;
selecting a first periodicity during the handshake association process;
sending client link status notification messages to the host by the at least one client according to the first periodicity;
negotiating a second periodicity between the host and the at least one client; and
updating the link status notification messages to the second periodicity.

2. The method of claim 1 further comprising the step of the host sending host link status notification messages to the at least one client asynchronously.

3. The method of claim 1 further comprising the step of the host sending a link status inquiry to the at least one client requesting the link status notification.

4. The method of claim 3 further comprising the step of synchronizing the client link status notification messages with a reception of the link status inquiry by the at least one client.

5. The method of claim 4 further comprising the step of the at least one client sending the client status notification messages synchronized to a reception of multiple consecutive host link status inquiry messages, wherein a multiple value has been negotiated between the host and the at least one client.

6. The method of claim 1 further comprising the steps of the at least one client sending a link status query to the host according the first periodicity and synchronizing a host link status response to the at least one client.

7. The method of claim 1 further comprising the step of the host and the at least one client periodically monitoring a link status.

8. The method of claim 1 wherein the first and second periodicity comprise a minimum supported periodicity.

9. The method of claim 1 further comprising the step of the host or the at least one client requesting an update of the second periodicity.

10. The method of claim 9 further comprising the step of confirming the updated second periodicity by the at least one client.

11. The method of claim 1 wherein the link status notification messages comprise at least one member from the group consisting of an average transmission PHY rate, an average reception PHY rate, an average transmission payload size, an average reception payload size, an average number of transmissions, a frame error rate, a received signal strength indication and a link quality indication.

12. The method of claim 1 wherein the step of updating the link status notification messages comprises updating a cadence of the link status messages.

13. A system for negotiating and updating a periodicity for link status notification messages between a host and at least one client in a digital communication system, the system comprising:
a processor;
means for exchanging periodicity parameters between the host and the at least one client during a handshake process in the processor;
means for selecting a first periodicity during the handshake process in the processor;
means for sending client link status notification messages to the host by the at least one client according to the first periodicity in the processor;
means for negotiating a second periodicity between the host and the at least one client in the processor; and
means for updating the link status notification messages to the second periodicity in the processor.

14. The system of claim 13 further comprising a means for sending host link status notification messages to the at least one client asynchronously by the host.

15. The system of claim 13 further comprising a means for sending a link status inquiry to the at least one client requesting the link status notification by the host.

16. The system of claim 15 further comprising a means for synchronizing the client link status notification messages with a reception of the link status inquiry by the at least one client.

17. The system of claim 16 further comprising a means for sending the client status notification messages by the at least one client, synchronized to a reception of multiple consecutive host link status inquiry messages, wherein a multiple value has been negotiated between the host and the at least one client.

18. The system of claim 13 further comprising a means for sending a link status query to the host according the first periodicity by the at least one client and a means for synchronizing a host link status response to the at least one client.

19. The system of claim 13 further comprising a means for periodically monitoring a link status by the host and the at least one client.

20. The system of claim 13 wherein the first and second periodicity comprise a minimum supported periodicity.

21. The system of claim 13 further comprising a means for requesting an update of the second periodicity by the host or the at least one client.

22. The system of claim 21 further comprising a means for confirming the updated second periodicity by the at least one client.

23. The system of claim 13 wherein the means for updating the link status notification messages comprises a means for updating a cadence of the link status notification messages.

24. The system of claim 13 wherein the link status notification messages comprise at least one member from the group consisting of an average transmission PHY rate, an average reception PHY rate, an average transmission payload size, an average reception payload size, an average number of transmissions, a frame error rate, a received signal strength indication and a link quality indication.

25. A storage media comprising program instructions which are computer-executable to implement a negotiation and an update of a periodicity for link status notification messages between a host and at least one client in a digital communication system, the storage media comprising:
program instructions that cause an exchange of periodicity parameters between the host and the at least one client during a handshake process;
program instructions that cause a selection of a first periodicity during the handshake process;
program instructions that cause client link status notification messages to be sent to the host by the at least one client according to the first periodicity;
program instructions that cause a negotiation of a second periodicity between the host and the at least one client; and
program instructions that cause an update of the link status notification messages to the second periodicity.

26. The storage media of claim 25 further comprising program instructions that cause the host to send host link status notification messages to the at least one client asynchronously.

27. The storage media of claim 25 further comprising program instructions that cause the host to send a link status inquiry to the at least one client requesting the link status notification.

28. The storage media of claim 27 further comprising program instructions that cause a synchronization of the client link status notification messages with a reception of the link status inquiry by the at least one client.

29. The storage media of claim 28 further comprising program instructions that causes the at least one client to send the client status notification messages synchronized to a reception of multiple consecutive host link status inquiry messages, wherein a multiple value has been negotiated between the host and the at least one client.

30. The storage media of claim 25 further comprising program instructions that cause the at least one client to send a link status query to the host according the first periodicity and program instructions that cause a synchronization of a host link status response to the at least one client.

31. The storage media of claim 25 further comprising program instructions that cause the host and the at least one client to periodically monitor a link status.

32. The storage media of claim 25 wherein the first and second periodicity comprise a minimum supported periodicity.

33. The storage media of claim 25 further comprising program instructions that cause the host or the at least one client to request an update of the second periodicity.

34. The storage media of claim 33 further comprising program instructions that cause a confirmation of the updated second periodicity by the at least one client.

35. The storage media of claim 25 wherein the link status notification messages comprises at least one member from the group consisting of an average transmission PHY rate, an average reception PHY rate, an average transmission payload size, an average reception payload size, an average number of transmissions, a frame error rate, a received signal strength indication and a link quality indication.

36. The storage media of claim 25 wherein the program instructions that cause an update of the link status notification messages comprise program instructions that cause an update of a cadence of the link status notification messages.
